(19) United States
(12) Patent Application Publication
(10) Pub. No.: US 2026/0222161 A1
(43) Pub. Date: Jul. 30, 2026

(54) ENHANCED RESOURCE DETERMINATION FOR A SIGNAL AND CHANNEL BASED ON SEMI-STATIC AND DYNAMIC DUPLEX CONFIGURATION FOR WIRELESS COMMUNICATIONS

(71) Applicant: INTEL CORPORATION, Santa Clara, CA (US)

(72) Inventors: Yi WANG, Beijing (CN); Debdeep CHATTERJEE, San Jose, CA (US); Yingyang LI, Beijing (CN); Gang XIONG, Hillsboro, OR (US); Sergey PANTELEEV, Leixlip (IE); Salvatore TALARICO, Sunnyvale, CA (US)

(73) Assignee: INTEL CORPORATION, Santa Clara, CA (US)

(21) Appl. No.: 19/146,363

(22) PCT Filed: Dec. 27, 2023
(86) PCT No.: PCT/US2023/086064

§ 371 Date: Jul. 8, 2025

Related U.S. Application Data
(60) Provisional application No. 63/485,501, filed on Feb. 16, 2023.

(51) Int. Cl. H04L 5/00; H04W 72/1273

(52) U.S. Cl. CPC H04L 5/0092; H04W 72/1273

(57) ABSTRACT

This disclosure describes systems, methods, and devices for configuring uplink and downlink transmissions in a full duplex system. A Next Generation Node B (gNB) device may configure an uplink frequency resource and a downlink frequency resource within a serving cell or bandwidth part for different symbols; provide a frequency resource configuration, indicative of the uplink frequency resource and the downlink frequency resource, to a user equipment (UE); provide, to the UE, a signal configuration or downlink control information (DCI) scheduling a signal transmission; and identify an uplink transmission from the UE based on the signal configuration and the frequency resource configuration, or provide a downlink transmission to the UE based on the signal configuration and the frequency resource configuration.

### CROSS-REFERENCE TO RELATED PATENT APPLICATION(S)

This application claims the benefit of U.S. Provisional Application No. 63/485,501, filed Feb. 16, 2023, the disclosure of which is incorporated herein by reference as if set forth in full.

### TECHNICAL FIELD

This disclosure generally relates to systems and methods for wireless communications and, more particularly, to wireless communication resource determination for a signal and channel based on semi-static and dynamic duplex configuration.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example network environment, in accordance with one or more example embodiments of the present disclosure.

FIG. 2 illustrates an example Sub-Band Full Duplex (SBFD)-based resource allocation in a serving cell, in accordance with one or more example embodiments of the present disclosure.

FIG. 3A illustrates an example frequency resource determination for a physical uplink shared control channel (PUSCH) transmission using rate matching, in accordance with one or more example embodiments of the present disclosure.

FIG. 3B illustrates an example frequency resource determination for a PUSCH transmission, in accordance with one or more example embodiments of the present disclosure.

FIG. 4 illustrates an example frequency resource determination for a PUSCH transmission, in accordance with one or more example embodiments of the present disclosure.

FIG. 5 illustrates an example frequency resource determination for a PUSCH transmission, in accordance with one or more example embodiments of the present disclosure.

FIG. 6 illustrates an example PUSCH repetition in a semi-statically configured SBFD symbol dynamically switched to a downlink symbol, in accordance with one or more example embodiments of the present disclosure.

FIG. 7 illustrates an example PUSCH repetition in a semi-statically configured SBFD symbol dynamically switched to an uplink symbol, in accordance with one or more example embodiments of the present disclosure.

FIG. 8 illustrates a flow diagram of illustrative process for SBFD-based resource allocation in a serving cell, in accordance with one or more example embodiments of the present disclosure.

FIG. 9. illustrates a network, in accordance with one or more example embodiments of the present disclosure.

FIG. 10 schematically illustrates a wireless network, in accordance with one or more example embodiments of the present disclosure.

FIG. 11 is a block diagram illustrating components, in accordance with one or more example embodiments of the present disclosure.

FIG. 12 illustrates a network, in accordance with one or more example embodiments of the present disclosure.

FIG. 13 illustrates a simplified block diagram of artificial (AI)-assisted communication between a user equipment and a radio access network, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may operate as defined by technical standards. For cellular telecommunications, the 3^{rd} Generation Partnership Program (3GPP) define communication techniques, including for time division duplex (TDD). In TDD communications, the time domain resource is split between downlink and uplink symbols. Allocation of a limited time duration for the uplink in TDD can result in reduced coverage and increased latency for a given target data rate. To improve the performance for uplink (UL) in TDD, simultaneous transmission/reception of downlink and uplink respectively, also referred to as “full duplex communication” can be considered. In this regard, the case of Non-Overlapping Sub-Band Full Duplex (SBFD) at the gNB is expected to be studied further in 3GPP.

For SBFD, within a carrier bandwidth or bandwidth part (BWP), some bandwidth can be allocated as UL, while some bandwidth can be allocated as DL within the same symbol, however the UL and DL resources are non-overlapping in frequency domain. Under this operational mode, at a given symbol a gNB can simultaneously transmit DL signals and receive UL signals, while a UE may only transmit or receive at a time.

For a UE not aware of support of SBFD at the gNB, the UE may only identify DL or UL resources in a symbol. For a UE that may be provided with the information of SBFD operations at gNB, the UE may identify both DL and UL resources in a symbol. The DL and UL resources in the symbol can be semi-statically determined or dynamically determined. UE may determine resource for a DL/UL signal/channel based on resource allocation for the signal/channel with consideration of DL and UL resources in a SBFD or non-SBFD symbol.

The present disclosure provides details for the determination of DL and UL resources for a DL/UL signal/channel according to semi-static or dynamic DL and UL resources in a SBFD or non-SBFD symbol. As a result, the enhanced techniques herein may enable flexible resource configurations and efficient operations in a full duplex communication system.

For a serving cell with SBFD operation, some symbols can only be used to map either DL or UL physical channels or signals (e.g., denoted as DL/UL/Flexible symbol), while some other symbols can be used to map both DL and UL physical channels or signals in the same symbol (denoted as symbol with potential SBFD operation). Thus, for a given PRB in a symbol with potential SBFD operation, the resources may be identified as DL, UL, or guard band. In one example, frequency resources within a symbol may be divided into DL/UL/guard resources in different non-overlapped sub-bands. A “sub-band” corresponds to a set of physical resources within a carrier that are contiguous in frequency, e.g., a number of consecutive Physical Resource Blocks (PRBs) on the Common Resource Block (CRB) grid. A DL, UL, or guard band can be explicitly or implicitly configured. In one example, DL and UL sub-band is explicitly configured and guard band is derived from PRBs between a DL and UL sub-band. In another example, UL sub-band and guard band is explicitly configured and DL sub-band is derived from remaining PRBs.

For semi-static sub-band information and dynamic sub-band information, the configuration of sub-bands including time (symbol and/or slot with DL) and frequency (PRBs) information for DL, UL or guard band may be provided to a UE via semi-static or dynamic signaling. In one option, the sub-band configuration is semi-statically provided by RRC signaling. In another option, the sub-band configuration is dynamically provided by a DCI. For example, both time and frequency information for DL, UL or guard band is provided by RRC signaling, thus SBFD and non-SBFD symbol and frequency location for DL, UL or guard band in a SBFD symbol is semi-statically determined. In addition, time information can be provided by DCI, which enables dynamic switch between legacy DL/UL/Flexible symbol (non-SBFD symbol) and SBFD symbol. Legacy DL/UL/Flexible symbol means only one direction is allowed in the symbol as legacy TDD system. It is noted that, if a symbol is determined as legacy DL/UL/Flexible symbol (non-SBFD symbol), the semi-statically configured DL, UL or guard band is considered as invalid. DL, UL or guard band is considered as valid only if the symbol is determined as SBFD symbol based on the dynamic indication.

In one embodiment of the invention, for dynamic sub-band configuration, the DCI format can be one of the existing non-fallback scheduling DCI formats used for DL assignment or UL grant. In one option, a new bit field can be added in the DL assignment or UL grant DCI to indicate the switch between SBFD symbol and non-SBFD symbol. The presence of the new bit field can be pre-defined and associated with configuration of SBFD-based operation or may be configured by RRC signaling.

In one example, the new bit field may include one bit, which indicates whether the symbol type (SBFD or non-SBFD symbol) is same as semi-static configuration. The new bit field can be added only in a DL assignment, or added in both DL assignment and UL grant. The symbol type can be determined according to at least one of the following mechanisms.
If the bit field indicates the symbol type is same as the semi-static configuration, the symbol type is determined by the semi-static configuration.
If the bit field indicates the symbol type is different from the semi-static configuration, and if the symbol type according to semi-static configuration is legacy DL or UL symbol, the symbol is switched to SBFD symbol.
If the bit field indicates the symbol type is different from the semi-static configuration, and if the symbol type according to semi-static configuration is legacy flexible symbol, the symbol is switched to SBFD symbol.
If the bit field indicates the symbol type is different from the semi-static configuration, and if the symbol type according to semi-static configuration is SBFD symbol, the symbol is switched to non-SBFD symbol.
   If the DCI is DL assignment, the symbol is switched to legacy DL symbol.
   If the DCI is UL grant, the symbol is switched to legacy UL symbol.

In another example, the new bit field may include one or more bits, which indicates the symbol type (SBFD or non-SBFD symbol). The symbol type can be SBFD symbol or non-SBFD symbol. The non-SBFD symbol can be indicated as one of legacy DL symbol, legacy UL symbol or legacy flexible symbol. For example, the new bit field includes one bit, which indicates SBFD symbol or legacy DL symbol. For another example, the new bit field includes 2 bits, which indicates one of SBFD symbol, legacy DL symbol, or legacy UL symbol.

The new bit field may apply to all symbols in a slot with a PDSCH/PUSCH scheduled by the DL assignment/UL grant (respectively). For example, if the DL assignment schedules a PDSCH in slot n, if the bit field indicates the symbol type as legacy DL symbol, it is assumed all symbols of the slot n is legacy DL symbol. Alternatively, the new bit field applies to the symbols of PDSCH/PUSCH scheduled by the DL assignment/UL grant. For example, if the DL assignment schedules a PDSCH in symbol 2-symbol 10 in slot n, if the bit field indicates the symbol type as legacy DL symbol, it is assumed all symbols of the PDSCH (symbol 2-symbol 10) is legacy DL symbol.

If the UL grant or DL assignment schedules multiple PUSCH/PDSCH transmissions occasions, e.g., PDSCH/PUSCH with repetitions, multi-PUSCH/PDSCH scheduling, transport block over multiple slots (TBoMS), the new bit field may apply to specific transmission/reception occasion(s). The specific transmission/reception occasion(s) can be first transmission/reception occasion, or all transmission/reception occasions, or all transmission/reception occasions in semi-statically configured SBFD symbols or all transmission/reception occasions in semi-statically configured non-SBFD symbols. Alternatively, if the UL grant or DL assignment schedules multiple PUSCH/PDSCH transmissions occasions, the new bit field is reserved or not presented in the DCI.

If the UL grant or DL assignment schedules multiple PUSCH/PDSCH transmissions occasions, the new bit field is configured with a bit-map based indication for each transmission/reception occasion or each group of transmission/reception occasions, where a group of transmission/reception occasions may consist of one or multiple transmission/reception occasions and the group size may be configured by RRC signaling or determined in accordance with the total number of transmission/reception occasions.

In another option, existing frequency domain resource allocation (FDRA) bit field in a DL assignment or UL grant DCI can implicitly indicate the switch between SBFD symbol and non-SBFD symbol. In one example, if a DL assignment schedules a PDSCH in a semi-statically configured SBFD symbol and FDRA indicates all PRBs in a semi-statically configured UL sub-band, it implicitly indicates the symbol switched to a legacy DL symbol. In another example, if a DL assignment schedules a PDSCH in a semi-statically configured SBFD symbol and FDRA indicates at least one RBG fully outside the semi-statically configured DL sub-band, it implicitly indicates the symbol switched to a legacy DL symbol. UE receives PDSCH on the indicated RBGs. Similarly, if a DL assignment schedules a PDSCH in a semi-statically configured non-SBFD symbol and FDRA indicates at least one RBG fully outside the semi-statically configured DL sub-band, it implicitly indicates the symbol is still a non-SBFD symbol, e.g., legacy DL symbol or flexible symbol. In another example, if a DL assignment schedules a PDSCH and FDRA is for resource allocation type 1, which indicates at least one RB outside the semi-statically configured DL sub-band, it implicitly indicates the symbol as a non-SBFD symbol. Similar mechanism can be applied for implicit indication by UL grant.

For dynamic sub-band configuration, the DCI can be a group common DCI, e.g., slot format information (SFI) or a new group common DCI, which indicates the symbol type or indicates whether the symbol type (SBFD or non-SBFD symbol) is same as semi-static configuration.

For dynamic sub-band configuration, in one option, UE does not expect to receive dynamic sub-band information, which leads to different symbol types (SBFD or non-SBFD symbol) of a DL/UL signal/channel.

The DL/UL signal/channel can be at least one of PDSCH/PDCCH/PUSCH/PUCCH/DL-PRS/PT-RS/CSI-RS/SRS/SSB/PRACH.

In another option, UE may not expect to receive dynamic sub-band information, which leads to different symbol types (SBFD or non-SBFD symbol) of a DL/UL signal/channel scheduled by a DL assignment/UL grant. In another option, UE does not expect to receive dynamic sub-band information which leads to different symbol types (SBFD or non-SBFD symbol) of a DL/UL signal/channel scheduled by a DL assignment/UL grant and the DL/UL signal/channel has single reception/transmission occasion, i.e., the DL/UL signal/channel is not configured with repetition or multi-PDSCH/PUSCH scheduling or TBoMS.

For dynamic sub-band indication, in one option, UE may not expect to receive dynamic sub-band information for any symbol of a DL/UL signal/channel dynamically scheduled or higher layer-configured with multiple reception/transmission occasions. In another option, UE may not expect to receive dynamic sub-band information for any symbol of a DL/UL signal/channel scheduled by a DL assignment/UL grant with multiple reception/transmission occasions. In another option, UE may not expect to receive dynamic sub-band information which leads to different frequency domain resource for different reception/transmission occasions of a DL/UL signal/channel. In another option, UE may not expect to receive dynamic sub-band information which leads to different frequency domain resource for different reception/transmission occasions of a DL/UL signal/channel scheduled by a DL assignment/UL grant.

It is noted, for some cases, dynamic sub-band information can be equivalent to indication of parameters associated with SBFD or non-SBFD symbols. For example, for PDSCH, gNB may configure two sets of parameters. The set of parameters may include one or more of: frequency domain resource, spatial domain resource (e.g., TCI or SRI), power domain resource (e.g., transmission power, open/close loop power control, power radio between SSB and DMRS). gNB can dynamically indicate which set of parameters is to be used.

For a frequency domain resource determination based on DL/UL sub-band, in a legacy TDD or FDD system, frequency domain resource for a signal/channel is typically provided with reference to a BWP, or with reference to a carrier, or with reference to CORESET 0, or with reference to CRB #0 or reference point A. For example, for PDSCH/PUSCH resource allocation type 0, the RBGs shall be indexed in the order of increasing frequency and starting at the lowest frequency of the BWP. For PDSCH/PUSCH resource allocation type 1, the PRBs shall be indexed in the order of increasing frequency and starting at the lowest frequency of the BWP.

In SBFD system, in one option (Option 1), frequency domain resource for a signal/channel may be determined in the same way as legacy TDD/FDD system, for example, with reference to a BWP, in both SBFD symbol and non-SBFD symbol. In SBFD system, in another option (Option 2), frequency domain resource for a signal/channel may be determined with reference to a BWP in a non-SBFD symbol and with reference to a DL/UL sub-band in a SBFD symbol. For example, for option 2, if PRB #n is indicated as starting PRB in FDRA, the starting PRB for a PUSCH is PRB #n within the active UL BWP where first PRB is the starting PRB of the active UL BWP, if the symbol is legacy UL symbol. If the symbol is SBFD symbol, the starting PRB for a PUSCH is PRB #(n mod (N UL_sub-band)+Nstart_UL_sub-band) within the active UL BWP, where Nstart_UL_sub-band is the starting PRB of a UL sub-band with reference to the active UL BWP, N UL sub-band is the number of PRBs for UL sub-band, If frequency hopping is configured, the starting PRB for 2nd hop of a PUSCH is PRB #((n+Nhop) mod (N UL_sub-band)+Nstart_UL_sub-band), where Nhop is frequency offset in RBs between the two frequency hops. For option 2, in one example, UE does not expect frequency domain resource for DL signal/channel determined with reference to DL sub-band in a SBFD symbol is not confined within the DL sub-band. UE does not expect the frequency domain resource for UL signal/channel determined with reference to UL sub-band in a SBFD symbol is not confined within the UL sub-band. In one example, UE does not expect the frequency domain resource for UL signal/channel determined with reference to UL sub-band in a SBFD symbol leads to non-contiguous frequency resources, e.g., a PUSCH is split between upper and lower part of a UL sub-band. In another example, UE may expect the frequency domain resource for UL signal/channel determined with reference to UL sub-band in a SBFD symbol leads to non-contiguous frequency resources, and UE cancels the UL transmission for this case.

In addition, for both options, rate matching/puncture/postpone/drop according to DL/UL sub-band in a SBFD symbol can be applied to avoid a DL signal/channel reception overlapping with a UL sub-band and/or guard band, or a UL signal/channel transmission overlapping with a DL sub-band and/or guard band.

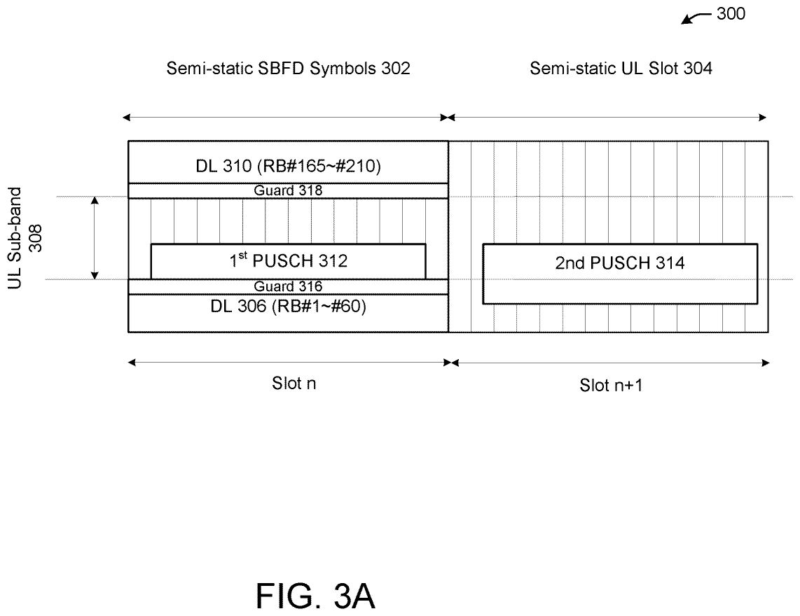

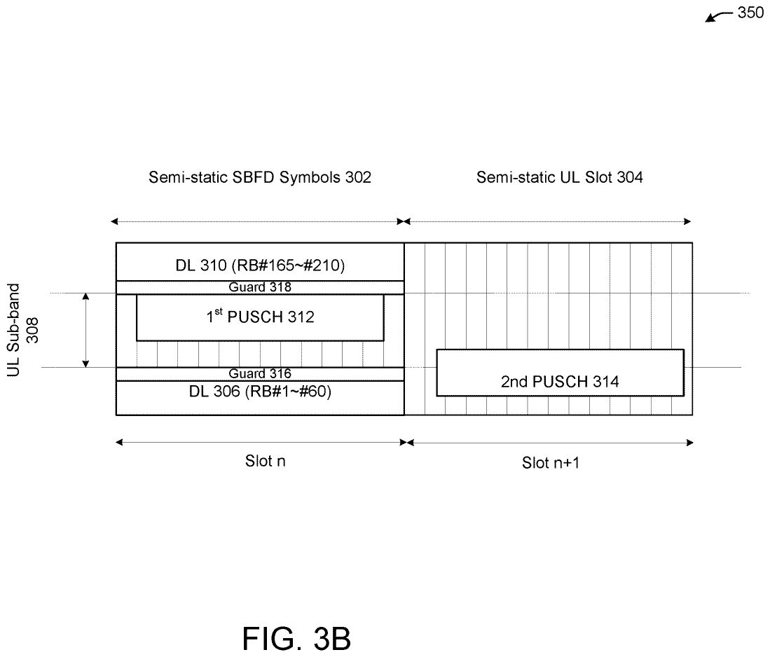

In one example, gNB configures RB #1~RB #60 as 1st DL sub-band, and RB #65~RB #160 with as UL sub-band, and RB #165~RB #210 as 2nd DL sub-band for slot n (SBFD symbols), and gNB configures slot n+1 as legacy UL slot (non-SBFD symbols). gNB configures RB #1~RB #210 as a DL/UL BWP for a UE. gNB schedules first PUSCH in RB #50~RB #89 in the slot n and second PUSCH in #50~RB #89 in slot n+1. For option 1, for both slot n and slot n+1, RB #50~RB #89 is with reference to UL BWP. In slot n, rate matching can be performed around DL sub-band and guard band, so 1st PUSCH is actually transmitted in RB #65~#89, which is confined within the UL sub-band. In slot n+1, 2nd PUSCH is actually transmitted in RB #50~#89. In FIG. 3, based on option 2, for slot n, RB #50~RB #89 is with reference to UL sub-band, so 1st PUSCH is actually transmitted in RB #114~RB #153 with reference to UL BWP. In slot n+1, 2nd PUSCH is actually transmitted in RB #50~#89 with reference to UL BWP. For both options above, the time and frequency information of DL, UL sub-band and guard band can be obtained from semi-static signaling and/or dynamic signaling.

For a resource determination of a signal/channel based on semi-static sub-band information, to determine reception/transmission of a signal/channel, UE can determine the resource of the signal/channel based on semi-static sub-band information in a first step, and UE can determine whether to receive/transmit the signal/channel or not based on dynamic sub-band information in a second step.

In first step, the determination of the resource of a signal/channel includes at least one of the following aspects,
Whether time domain resource of a signal/channel in a set of symbols collides with the symbol type based on semi-static sub-band information.
Collision between time domain resource of a DL/UL signal/channel and the symbol type based on semi-static sub-band information is identified, if the DL/UL signal/channel is in legacy UL/DL symbols (non-SBFD symbols) based on the semi-static sub-band information.
If collision is identified by UE, the signal/channel is dropped/postponed regardless of dynamic sub-band information.
For example, for a CG PUSCH in a set of legacy DL symbols based on the semi-static sub-band information, UE drops the CG PUSCH, even if dynamic sub-band information switches the set of symbols to SBFD symbols.
Determine frequency domain resource of a signal/channel in a set of symbols based on semi-static sub-band information
For example, for a PUSCH in a semi-statically configured SBFD symbol, frequency resource is determined with reference to UL sub-band based on semi-static sub-band information. If a PUSCH is in a semi-statically configured legacy UL symbol, frequency resource is determined with reference to UL BWP based on semi-static sub-band information.
Since the frequency domain resource is determined based on semi-static sub-band information, miss-detection of dynamic indication does not cause miss-alignment between gNB and UE for the frequency domain resource.

In one option, UE does not expect a UL signal/channel scheduled by a UL grant to be collided with legacy DL symbol provided by the dynamic indication. UE does not expect a DL signal/channel scheduled by a DL assignment to be collided with legacy UL symbol provided by the dynamic indication.

In one option, UE does not expect a UL signal/channel scheduled by a UL grant with single transmission occasion to be collided with legacy DL symbol provided by the dynamic indication. UE does noy expect a DL signal/channel scheduled by a DL assignment with single transmission occasion to be collided with legacy UL symbol provided by the dynamic indication.

In one option, UE does not expect the frequency domain resource of a DL signal/channel to be collided with valid UL sub-band and guard band provided by the dynamic indication, if the DL signal/channel is dynamically scheduled by gNB. UE does not expect the frequency domain resource of a UL signal/channel to be collided with valid DL sub-band and guard band provided by the dynamic indication, if the UL signal/channel is dynamically scheduled by gNB.

In one option, UE does not expect the frequency domain resource of a DL signal/channel to be collided with valid UL sub-band and guard band provided by the dynamic indication, if the DL signal/channel is dynamically scheduled by gNB and the DL signal/channel has single transmission occasion. UE does not expect the frequency domain resource of a UL signal/channel to be collided with valid DL sub-band and guard band provided by the dynamic indication, if the UL signal/channel is dynamically scheduled by gNB and the UL signal/channel has single transmission occasion.

In one option, UE may expect a UL signal/channel to be collided with legacy DL symbol provided by the dynamic indication or a DL signal/channel to be collided with legacy UL symbol provided by the dynamic indication, if the DL/UL signal/channel is higher-layer configured signal/channel.

In one option, UE may expect the frequency domain resource of a DL signal/channel to be collided with valid UL sub-band and guard band provided by the dynamic indication, or UL signal/channel to be collided with valid DL sub-band and guard band provided by the dynamic indication, if the DL/UL signal/channel is higher-layer configured signal/channel.

In second step, if UE identifies the collision between legacy DL/UL symbol provided by the dynamic sub-band information and a UL/DL signal/channel determined based on semi-static sub-band information in first step, UE drops the signal/channel.

In the second step, if UE identifies the collision between the valid sub-band or guard band provided by the dynamic sub-band information and the frequency domain resource for a signal/channel determined based on semi-static sub-band information in first step, UE drops the signal/channel.

In an example for PDSCH resource determination, PDSCH frequency resource is determined based on Option 1 above (option 1 in Frequency domain resource determination based on DL/UL sub-band section). gNB schedules first PDSCH in RB #1~RB #80 in the slot n and second PDSCH in RB #1~RB #80 in slot n+1. In slot n, based on semi-static sub-band configuration, all symbols in slot n are SBFD symbols. 1st PDSCH is rate matched around guard band and UL sub-band so that 1st PDSCH is in RB #1~RB #60. In slot n+1, based on semi-static sub-band configuration, all symbols in slot n are non-SBFD symbols. 2nd PDSCH is in RB #1~RB #80. The dynamic sub-band configuration switches symbols in slot n to legacy DL symbols. UE still only receives 1st PDSCH in RB #1~RB #60. Then, even if dynamic sub-band information DCI is miss-detected by UE, gNB and UE shares same understanding for PDSCH rate matching in slot n.

In another example for PDSCH frequency resource determination, the PDSCH frequency resource is determined based on Option 1 above (option 1 in Frequency domain resource determination based on DL/UL sub-band section). gNB schedules first PDSCH in RB #1~RB #80 in the slot n and second PDSCH in RB #1~RB #80 in slot n+1. In slot n, based on semi-static sub-band configuration, all symbols in slot n are legacy DL symbols. 1st PDSCH is in RB #1~RB #80. The dynamic sub-band information switches symbols in slot n to SBFD symbols. Because 1st PDSCH overlaps with UL sub-band and guard band, UE drops 1st PDSCH.

For a resource determination of a signal/channel based on sub-band information, to determine reception/transmission of a signal/channel, UE can determine the resource of the signal/channel based on dynamic sub-band information.
UE can determine whether time domain resource of a signal/channel in a set of symbols collides with the symbol type based on dynamic sub-band information.
For example, for a CG PUSCH in a set of legacy DL symbols based on the semi-static sub-band information, if the UE receives dynamic sub-band information which switches the set of symbols to SBFD symbols, UE assumes the CG PUSCH can be transmitted based on SBFD symbols.
For another example, for a CG PUSCH in a set of SBFD symbols based on the semi-static sub-band information, and if the UE receives dynamic sub-band information which switches the set of symbols to legacy DL symbols, UE identifies the collision, so UE cancels the CG PUSCH.
UE can determine frequency domain resource of a signal/channel in a set of symbols based on dynamic sub-band information
For example, for a PUSCH in a semi-statically configured SBFD symbol, if the UE receives dynamic sub-band information which switches the set of symbols to legacy UL symbols, frequency resource is determined with reference to UL BWP based on dynamic sub-band information. If a PUSCH is in a semi-statically configured legacy flexible symbol and the UE receives dynamic sub-band information which switches the set of symbols to SBFD symbols, frequency resource is determined with reference to UL sub-band based on dynamic sub-band information.
Since the frequency domain resource is determined based on dynamic sub-band information, frequency resource can be fully utilized.

For the above embodiments, for different signals/channels, different embodiments can be applied.

In one option, for higher-layer configured DL/UL signal/channel, the resource is determined based on the dynamic sub-band information.

In one option, for higher-layer configured DL/UL signal/channel, in symbols which may be dynamically switched by dynamic sub-band information, the resource is determined based on the dynamic sub-band information, if the DCI carrying the dynamic sub-band information is received by the UE. If UE does receive the DCI carrying the dynamic sub-band information for the symbols, UE drops the DL/UL signal/channel.

In one option, for DL/UL signal/channel with multiple reception/transmission occasions scheduled by a DL assignment/UL grant, the resource is determined based on the semi-static sub-band information, if the dynamic sub-band information is not provided by the DL assignment/UL grant. For example, the dynamic sub-band information can be provided in a DCI other than the DL assignment/UL grant.

In one option, for DL/UL signal/channel with multiple reception/transmission occasions scheduled by a DL assignment/UL grant, the resource is determined based on the dynamic sub-band information, if the dynamic sub-band information is carried by the DL assignment/UL grant.

In one option, for scheduled DL/UL signal/channel, frequency domain resource is determined based on the semi-static sub-band information, if the dynamic sub-band information is not provided by the DL assignment/UL grant scheduling the DL/UL signal/channel. For example, the dynamic sub-band information can be provided in a DCI other than the DL assignment/UL grant.

In one option, for scheduled DL/UL signal/channel, frequency domain resource is determined based on the dynamic sub-band information, if the dynamic sub-band information is provided by the DL assignment/UL grant scheduling the DL/UL signal/channel.

In one option, for scheduled DL/UL signal/channel with single reception/transmission occasion, frequency domain resource is determined based on the dynamic sub-band information, if the dynamic sub-band information is provided by the DL assignment/UL grant scheduling the DL/UL signal/channel.

For frequency domain resource determination and available slot counting, a PUSCH transmission with repetition type A or with transport block over multiple slots (TBoMS), counting based on available slots can be supported based on gNB configuration. Similar mechanism is also applied for physical uplink control channel (PUCCH) repetitions and SRS transmission in unpaired spectrum or half-duplex (HD)-FDD. For example, the aperiodic SRS resource set triggered by a DCI could be transmitted in the (t+1)-th available slot counting from a reference slot, wherein t is configured by higher-layer signaling with or without indication by DCI.

For available slot counting, a two-step approach can be employed, where in a first step, a UE determines available slots for K repetitions based on DL/UL configuration in addition to time domain resource allocation and frequency domain resource for PUSCH/PUCCH/SRS. In a second step, the UE determines whether to drop a PUSCH repetition/PUCCH repetition/SRS or not according to dynamic DL/UL information, but the PUSCH repetition/PUCCH repetition is still counted in the K repetitions and SRS is still counted as transmitted without further deferral.

The DL/UL configuration can be semi-static DL/UL configuration which includes semi-static configuration for sub-band. In one option, in a first step, if a PUSCH/PUCCH/SRS is in SBFD symbols determined by the semi-static DL/UL configuration, the slot of the PUSCH/PUCCH/SRS is counted as available slot, otherwise, the slot is not counted as available slot. In a second step, for an available slot determined in the first step, if UE identifies the frequency domain resource of the PUSCH/PUCCH/SRS to collide with valid DL sub-band and guard band provided by dynamic sub-band information, or if UE identifies the PUSCH/PUCCH/SRS to collide with legacy DL symbol (non-SBFD symbol) provided by dynamic sub-band information, the UE cancels the PUSCH/PUCCH/SRS and does not postpone the cancelled PUSCH/PUCCH/SRS transmission. With this option, it can be assumed that gNB always ensures the frequency resource of a PUSCH/PUCCH/SRS derived based on semi-static sub-band configuration is confined within UL sub-band. Therefore, UE only needs to check time domain resource in the first step.

In one example of PUSCH with two repetitions, slot n+1 consists of SBFD symbols based on semi-static sub-band configuration, and the symbols are dynamically switched to DL symbols based on dynamic sub-band information. For PUSCH repetition #2 in slot n+1, frequency resource of the PUSCH is determined with reference to UL sub-band based on semi-static sub-band configuration, which is confined within UL sub-band. Therefore, slot n+1 is counted as available slot in the first step. UE identifies symbols in slot n+1 switches to DL symbol based on dynamic sub-band information. Therefore, UE drops the PUSCH in slot n+1 in the second step.

In another option, if a PUSCWPUCCH/SRS is in SBFD symbols determined by the semi-static DL/UL configuration, and the frequency domain resource of the PUSCH/PUCCH/SRS are confined within the UL sub-band, the slot of the PUSCH/PUCCH/SRS is counted as available slot, otherwise, the slot is not counted as available slot. In a first step, the frequency domain resource of the PUSCH/PUCCH/SRS can be determined based on semi-static sub-band configuration. For one example, based on option 1 in Frequency domain resource determination based on DL/UL sub-band section, frequency domain resource for a PUSCH is determined with reference to a BWP regardless of SBFD symbol and non-SBFD symbol. In a first step, if the symbol is SBFD symbol based on semi-static sub-band configuration, and if all PRBs of the PUSCH is confined within UL sub-band, the slot is counted as available slot. If at least one of PRBs of the PUSCH is outside UL sub-band, the slot is counted as unavailable slot. If the symbol is flexible symbol based on semi-static sub-band configuration, the slot is counted as available slot. In a second step, for an available slot determined in the first step, if UE identifies the frequency domain resource of the PUSCH/PUCCH/SRS to collide with valid DL sub-band and guard band provided by dynamic sub-band information, or if UE identifies the PUSCH/PUCCH/SRS to collide with legacy DL symbol (non-SBFD symbol) provided by dynamic sub-band information, the UE cancels the PUSCH/PUCCH/SRS.

In another example of PUSCH with two repetitions, slot n+1 consists of semi-static SBFD symbol based on semi-static sub-band configuration, and the symbols are dynamically switched to legacy UL symbols based on dynamic sub-band information. For PUSCH repetition #2 in slot n+1, frequency resource of the PUSCH is determined with reference to UL BWP. Since the PUSCH overlaps with semi-static DL sub-band, the PUSCH repetition #2 is postponed to next slot n+2 with semi-static UL slot. The slot n+1 is not counted as available slot in the first step. UE does not to check slot n+1 in the second step though the slot n+1 is switched to full UL slot.

For the above embodiments, if dynamic sub-band information leads to cancelation of a UL signal/channel, the gap between DCI for dynamic sub-band information and the UL signal/channel should provide sufficient time for cancellation of the UL transmission. In an example, the gap between the last symbol of a CORESET where the UE detects the DCI format with dynamic sub-band information and the first symbol from which a UL signal/channel may be cancelled may be specified to be at least T_(proc,2), where T_(proc,2) is the PUSCH preparation time for the corresponding UE processing capability (e.g., 3GPP technical standard 38.214) assuming d_2,1=1 and g corresponds to the smallest SCS configuration between the SCS configuration of the PDCCH carrying the DCI format and the SCS configuration of the SRS, PUCCH, PUSCH or μ_r, where μ_r corresponds to the SCS configuration of the PRACH if it is 15 kHz or higher; otherwise μ_r=0.

For above embodiments, if frequency resource of a UL signal/channel is determined by dynamic sub-band information, the gap between DCI for dynamic sub-band information and the UL signal/channel should provide sufficient time for UL signal/channel transmission preparation. In an example, the gap between the last symbol of a CORESET where the UE detects the DCI format with dynamic sub-band information and the first symbol from which a UL signal/channel may be transmitted may be specified to be at least T_(proc,2), where T_(proc,2) is the PUSCH preparation time for the corresponding UE processing capability (e.g., 3GPP technical standard 38.214) assuming d_2,1=1 and p corresponds to the smallest SCS configuration between the SCS configuration of the PDCCH carrying the DCI format and the SCS configuration of the SRS, PUCCH, PUSCH or μ_r, where μ_r corresponds to the SCS configuration of the PRACH if it is 15 kHz or higher; otherwise μ_r=0. In another example, for UL signals/channels other than PUSCH, the minimum preparation time may be defined different from that of the PUSCH preparation time.

If frequency resource of a DL signal/channel is determined by dynamic sub-band information, the gap between DCI for dynamic sub-band information and the DL signal/channel should provide sufficient time for DL signal/channel reception preparation. In an example, the minimum reception preparation time may include the minimum time for PDCCH decoding and any Tx-to-Rx switching time, if applicable. Furthermore, such minimum processing timeline for DL signal/channel reception preparation may be defined for cases wherein a legacy UL symbol may be switched to an SBFD with DL reception.

For a resource determination for UCI multiplexing based on semi-static or dynamic sub-band configuration, for UCI multiplexing, in one option, PUCCH(s) and PUSCH(s) to be multiplexed is based on semi-static sub-band information. After multiplexing, the availability of resultant PUSCH or resultant PUCCH is checked based on dynamic sub-band information. If the collision happens, e.g., if symbols of a resultant PUSCH in semi-static SBFD symbols switches to legacy DL symbol based on dynamic sub-band information, the resultant PUSCH is dropped. For another example, if a resultant PUSCH in flexible symbols overlaps with valid DL sub-band or guard band based on dynamic sub-band information, the resultant PUSCH is dropped.

In another option, the candidate PUSCH(s) for UCI multiplexing is determined based on dynamic sub-band information. For example, if a PUSCH collides with legacy DL symbol or a PUSCH overlaps with valid DL sub-band or guard band based on dynamic sub-band information, the PUSCH is excluded from the candidate PUSCHs for UCI multiplexing.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

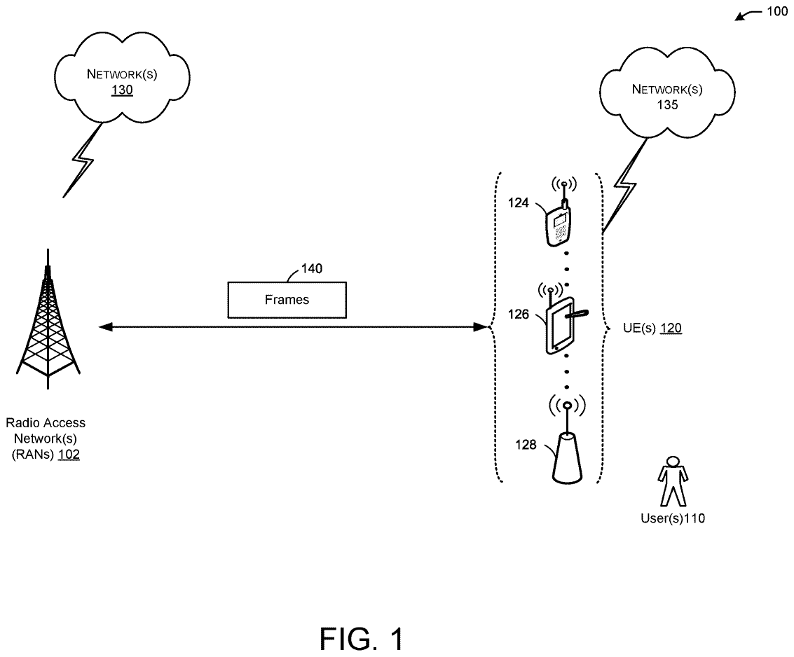

FIG. 1 is a network diagram illustrating an example network environment 100, in accordance with one or more example embodiments of the present disclosure.

Wireless network 100 may include one or more UEs 120 and one or more RANs 102 (e.g., gNBs), which may communicate in accordance with 3GPP communication standards. The UE(s) 120 may be mobile devices that are non-stationary (e.g., not having fixed locations) or may be stationary devices.

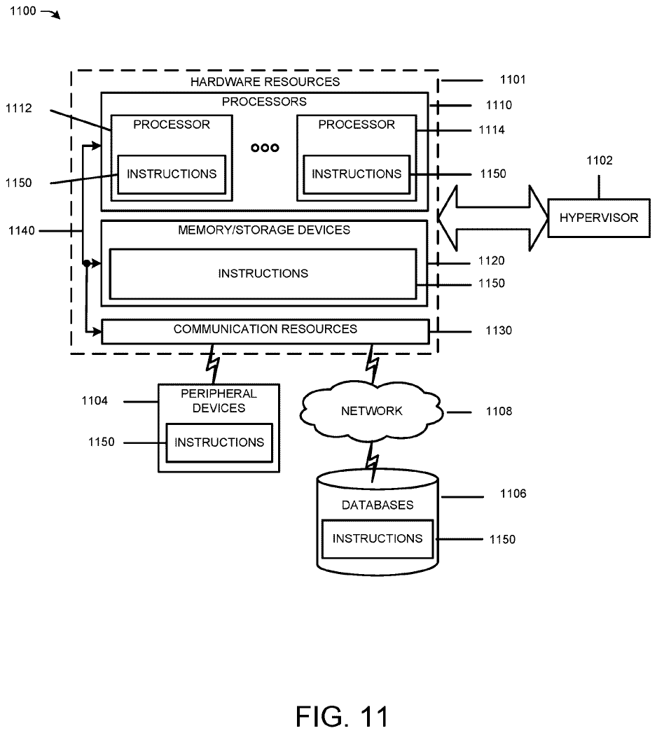

In some embodiments, the UEs 120 and the RANs 102 may include one or more computer systems similar to that of FIGS. 11-13.

One or more illustrative UE(s) 120 and/or RAN(s) 102 may be operable by one or more user(s) 110. A UE may take on multiple distinct characteristics, each of which shape its function. For example, a single addressable unit might simultaneously be a portable UE, a quality-of-service (QoS) UE, a dependent UE, and a hidden UE. The UE(s) 120 (e.g., 124, 126, or 128) and/or RAN(s) 102 may include any suitable processor-driven device including, but not limited to, a mobile device or a non-mobile, e.g., a static device. For example, UE(s) 120 may include, a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE(s) 120 (e.g., UEs 124, 126, 128), and UE(s) 120 may be configured to communicate with each other via one or more communications networks 130 and/or 135 wirelessly or wired. The UE(s) 120 may also communicate peer-to-peer or directly with each other with or without the RAN(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, cellular networks. In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the UE(s) 120 (e.g., UE 124, 126, 128) and RAN(s) 102 may include one or more communications antennas. The one or more communications antennas may be any suitable type of antennas corresponding to the communications protocols used by the UE(s) 120 (e.g., UEs 124, 126 and 128), and RAN(s) 102. Some non-limiting examples of suitable communications antennas include cellular antennas, 3GPP family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UEs 120 and/or RAN(s) 102.

Any of the UE(s) 120 (e.g., UE 124, 126, 128), and RAN(s) 102 may be configured to perform directional transmission and/or directional reception in conjunction with wirelessly communicating in a wireless network. Any of the UE(s) 120 (e.g., UE 124, 126, 128), and RAN(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the UE(s) 120 (e.g., UE 124, 126, 128), and RAN(s) 102 may be configured to perform any given directional transmission towards one or more defined transmit sectors. Any of the UE(s) 120 (e.g., UE 124, 126, 128), and RAN(s) 102 may be configured to perform any given directional reception from one or more defined receive sectors.

MIMO beamforming in a wireless network may be accomplished using RF beamforming and/or digital beamforming. In some embodiments, in performing a given MIMO transmission, UE 120 and/or RAN(s) 102 may be configured to use all or a subset of its one or more communications antennas to perform MIMO beamforming.

Any of the UE 120 (e.g., UE 124, 126, 128), and RAN(s) 102 may include any suitable radio and/or transceiver for transmitting and/or receiving radio frequency (RF) signals in the bandwidth and/or channels corresponding to the communications protocols utilized by any of the UE(s) 120 and RAN(s) 102 to communicate with each other. The radio components may include hardware and/or software to modulate and/or demodulate communications signals according to pre-established transmission protocols. The radio components may further have hardware and/or software instructions to communicate via one or more 3GPP protocols and using 3GPP bandwidths. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more of the UEs 120 may exchange frames 140 with the RANs 102. The frames 140 may include UL and DL frames, including SBFD and non-SBFD symbols, simultaneous transmission, resource signaling, and the like as described throughout the present disclosure.

It is understood that the above descriptions are for purposes of illustration and are not meant to be limiting.

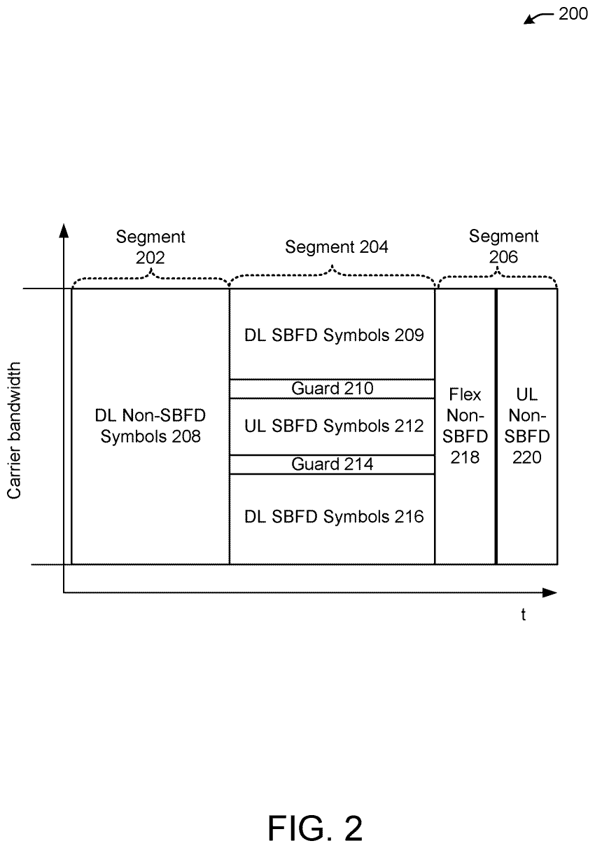

FIG. 2 illustrates an example Sub-Band Full Duplex (SBFD)-based resource allocation 200 in a serving cell, in accordance with one or more example embodiments of the present disclosure.

Referring to FIG. 2, non-SBFD symbols and SBFD symbols may be transmitted across multiple time segments (e.g., segment 202, segment 204, segment 206). For example, DL non-SBFD symbols 208 may be transmitted in segment 202. DL SBFD symbols 209, followed by a guard 210, followed by UL SBFD symbols 212, followed by a guard 214, followed by DL SBFD symbols 216 may be transmitting in segment 204. In segment 206, flexible non-SBFD symbols 218 and UL non-SBFD symbols 220 may be transmitted.

For a serving cell with SBFD operation, some symbols can only be used to map either DL or UL physical channels or signals (e.g., denoted as DL/UL/flexible symbols), while some other symbols can be used to map both DL and UL physical channels or signals in the same symbol (e.g., denoted as symbol with potential SBFD operation). Thus, for a given PRB in a symbol with potential SBFD operation, the resources may be identified as DL, UL, or guard band as illustrated in FIG. 2. In one example, frequency resources within a symbol may be divided into DL/UL/Guard resources in different non-overlapped sub-bands. Here and in the rest of the disclosure, a “sub-band” corresponds to a set of physical resources within a carrier that are contiguous in frequency, e.g., a number of consecutive Physical Resource Blocks (PRBs) on the Common Resource Block (CRB) grid. A DL, UL, or guard band can be explicitly or implicitly configured. In one example, DL and UL sub-band is explicitly configured and guard band is derived from PRBs between a DL and UL sub-band. In another example, UL sub-band and guard band is explicitly configured and DL sub-band is derived from remaining PRBs.

FIG. 3A illustrates an example frequency resource determination for a physical uplink shared control channel (PUSCH) transmission 300 using rate matching, in accordance with one or more example embodiments of the present disclosure.

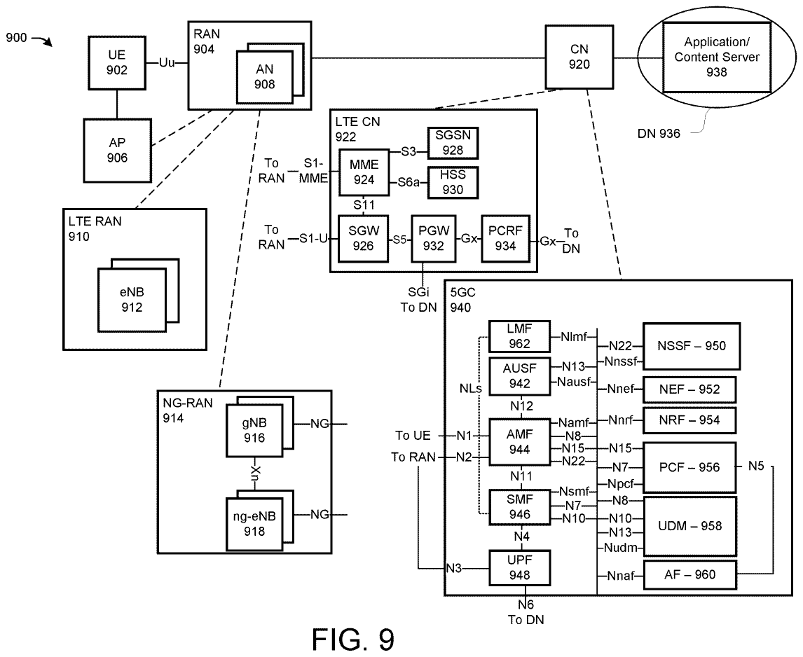

Referring to FIG. 3A, semi-static SBFD symbols may be transmitted during a time slot n, and semi-static UL symbols 304 may be transmitted during a time slot n+1. For example, a gNB (e.g., gNB 916 of FIG. 9) may configure RB #1~RB #60 as a 1st DL sub-band 306, and RB #65~RB #160 with as a UL sub-band 308, and RB #165~RB #210 as 2nd DL sub-band 310 for a slot n (SBFD symbols), and the gNB may configure a slot n+1 as a legacy UL slot (non-SBFD symbols). The gNB may configure RB #1~RB #210 as a DL/UL BWP for a UE (e.g., gNB 916 of FIG. 9). The gNB schedules a first PUSCH 312 in RB #50~RB #89 in the slot n and second PUSCH 314 in #50~RB #89 in slot n+1. In FIG. 3A, based on option 1, for both slot n and slot n+1, RB #50~RB #89 is with reference to UL BWP. In slot n, rate matching can be performed around the DL sub-bands and guard bands (e.g., guard 316, guard 318), so the 1st PUSCH 312 is actually transmitted in RB #65~#89, which is confined within the UL sub-band 308. In slot n+1, the 2nd PUSCH 314 is actually transmitted in RB #50~#89.

FIG. 3B illustrates an example frequency resource determination for a PUSCH transmission 350, in accordance with one or more example embodiments of the present disclosure.

In FIG. 3B, based on option 2, for slot n, RB #50~RB #89 is with reference to the UL sub-band 308, so the 1st PUSCH 312 is actually transmitted in RB #114~RB #153 with reference to UL BWP. In slot n+1, the 2nd PUSCH 314 is actually transmitted in RB #50~#89 with reference to UL BWP.

Referring to FIG. 3A and FIG. 3B, In SBFD system, in one option (e.g., FIG. 3A), the frequency domain resource for a signal/channel may be determined in the same way as legacy TDD/FDD system, for example, with reference to a BWP, in both SBFD symbol and non-SBFD symbol. In a SBFD system, in another option (Option 2—FIG. 3B), a frequency domain resource for a signal/channel may be determined with reference to a BWP in a non-SBFD symbol and with reference to a DL/UL sub-band in a SBFD symbol. For example, for option 2, if PRB #n is indicated as starting PRB in FDRA, the starting PRB for a PUSCH is PRB #n within the active UL BWP where first PRB is the starting PRB of the active UL BWP, if the symbol is legacy UL symbol. If the symbol is SBFD symbol, the starting PRB for a PUSCH is PRB #(n mod (N UL_sub-band)+Nstart_UL_sub-band) within the active UL BWP, where Nstart_UL_sub-band is the starting PRB of a UL sub-band with reference to the active UL BWP, N UL_sub-band is the number of PRBs for UL sub-band, If frequency hopping is configured, the starting PRB for 2nd hop of a PUSCH is PRB #((n+Nhop) mod (N UL_sub-band)+Nstart_UL_sub-band), where Nhop is frequency offset in RBs between the two frequency hops. For option 2, in one example, UE does not expect frequency domain resource for DL signal/channel determined with reference to DL sub-band in a SBFD symbol is not confined within the DL sub-band. UE does not expect the frequency domain resource for UL signal/channel determined with reference to UL sub-band in a SBFD symbol is not confined within the UL sub-band. In one example, UE does not expect the frequency domain resource for UL signal/channel determined with reference to UL sub-band in a SBFD symbol leads to non-contiguous frequency resources, e.g., a PUSCH is split between upper and lower part of a UL sub-band. In another example, UE may expect the frequency domain resource for UL signal/channel determined with reference to UL sub-band in a SBFD symbol leads to non-contiguous frequency resources, and UE cancels the UL transmission for this case.

For both options above, the time and frequency information of DL, UL sub-band and guard band can be obtained from semi-static signaling and/or dynamic signaling.

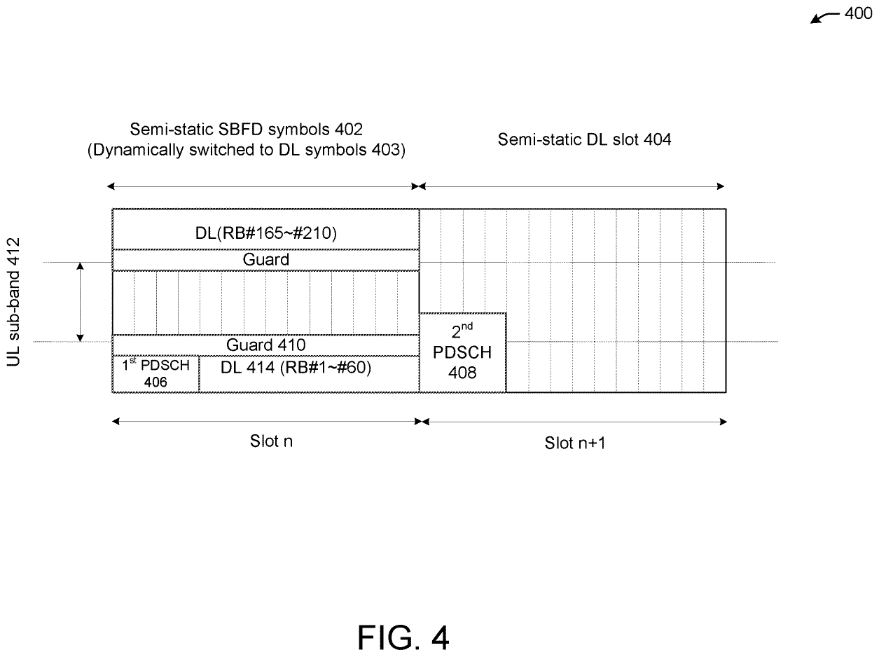

FIG. 4 illustrates an example frequency resource determination for a PUSCH transmission 400, in accordance with one or more example embodiments of the present disclosure.

FIG. 4 provides an example for PDSCH resource determination. A PDSCH frequency resource is determined based on Option 1 above. There may be semi-static SBFD symbols 402 dynamically switched to DL symbols in slot n, and semi-static DL slot 404 symbols in slot n+1. A gNB (e.g., gNB 916 of FIG. 9) schedules a first PDSCH 406 in RB #1~RB #80 in the slot n and a second PDSCH 408 in RB #l-RB #80 in slot n+1. In slot n, based on a semi-static sub-band configuration, all symbols in slot n are SBFD symbols. The 1st PDSCH 406 is rate matched around a guard band 410 and a UL sub-band 412 so that the 1st PDSCH 406 is in RB #1~RB #60. In slot n+1, based on a semi-static sub-band configuration, all symbols in slot n are non-SBFD symbols. The 2nd PDSCH 408 is in RB #1~RB #80. The dynamic sub-band configuration switches symbols in slot n to legacy DL symbols 414. UE still only receives the 1st PDSCH 406 in RB #1~RB #60. Then, even if dynamic sub-band information DCI is miss-detected by UE, gNB and UE share a same understanding for PDSCH rate matching in slot n.

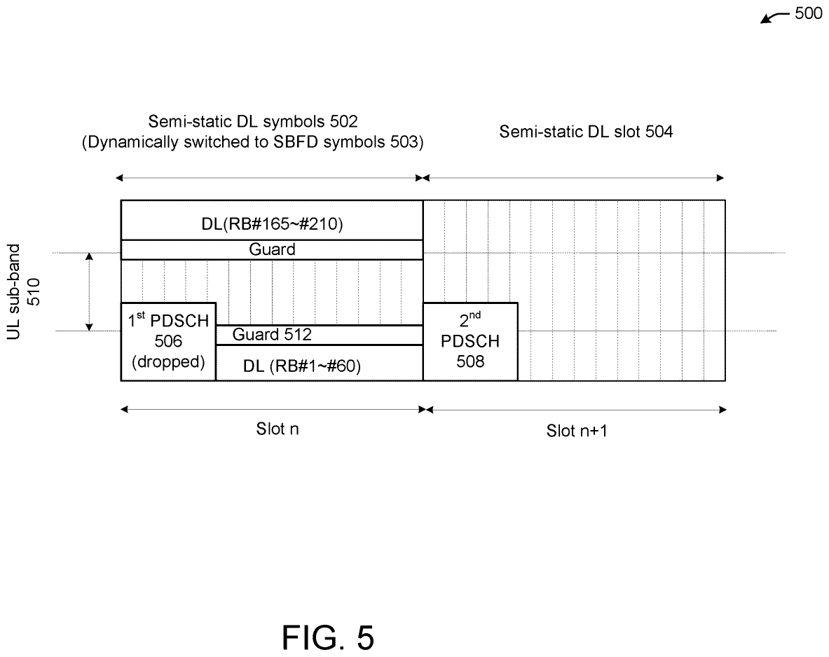

FIG. 5 illustrates an example frequency resource determination for a PUSCH transmission 500, in accordance with one or more example embodiments of the present disclosure.

Referring to FIG. 5, a PDSCH frequency resource is determined based on Option 1 above. There may be semi-static SBFD symbols 402 dynamically switched to DL symbols in slot n, and semi-static DL slot 404 symbols in slot n+1. A gNB (e.g., gNB 916 of FIG. 9) schedules a first PDSCH 506 in RB #1~RB #80 in the slot n and a second PDSCH 508 in RB #1~RB #80 in slot n+1. In slot n, based on a semi-static sub-band configuration, all symbols in slot n are legacy DL symbols. The 1st PDSCH 506 is in RB #1~RB #80. The dynamic sub-band information switches symbols 502 in slot n to SBFD symbols 503. Because the 1st PDSCH 506 overlaps with a UL sub-band 510 and guard band 512, UE drops the 1st PDSCH 506.

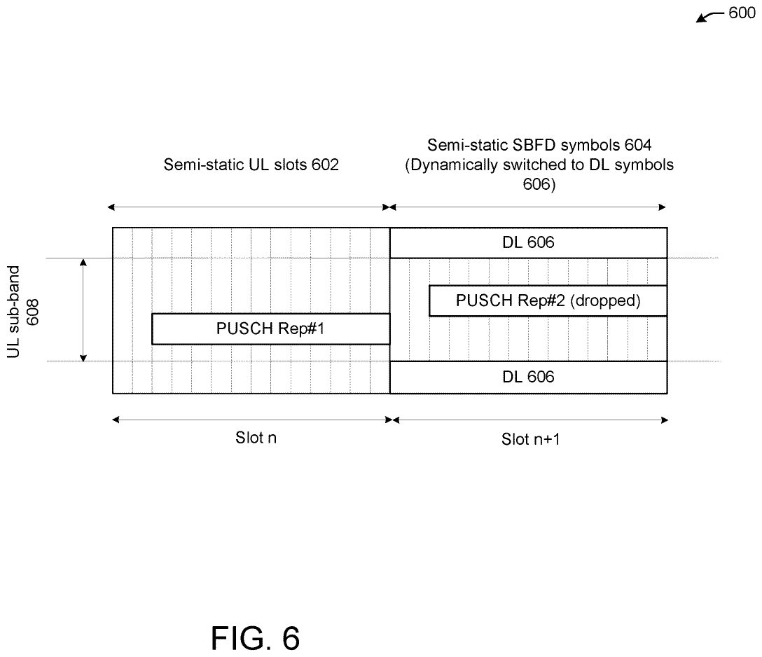

FIG. 6 illustrates an example PUSCH repetition 600 in a semi-statically configured SBFD symbol dynamically switched to a downlink symbol, in accordance with one or more example embodiments of the present disclosure.

FIG. 6 provides an example of PUSCH with two repetitions. There may be semi-static UL slots 602 and semi-static SBFD symbols 604 dynamically switched to DL symbols 606. Slot n+1 consists of SBFD symbols 604 based on a semi-static sub-band configuration, and the SBFD symbols 604 are dynamically switched to DL symbols 606 based on a dynamic sub-band information. For PUSCH repetition #2 in slot n+1, a frequency resource of the PUSCH is determined with reference to a UL sub-band 608 based on a semi-static sub-band configuration, which is confined within the UL sub-band 608. Therefore, slot n+1 is counted as an available slot in the first step. A UE (e.g., UE 902 of FIG. 9) identifies symbols in slot n+1 and switches to DL symbols 606 based on dynamic sub-band information. Therefore, UE drops the PUSCH in slot n+1 in the second step.

In another option, if a PUSCH/PUCCH/SRS is in SBFD symbols determined by the semi-static DL/UL configuration, and the frequency domain resource of the PUSCH/PUCCH/SRS are confined within the UL subband, the slot of the PUSCH/PUCCH/SRS is counted as available slot, otherwise, the slot is not counted as available slot. In a first step, the frequency domain resource of the PUSCH/PUCCH/SRS can be determined based on semi-static subband configuration. For one example, based on option 1 in Frequency domain resource determination based on DL/UL subband section, frequency domain resource for a PUSCH is determined with reference to a BWP regardless of SBFD symbol and non-SBFD symbol. In a first step, if the symbol is SBFD symbol based on semi-static subband configuration, and if all PRBs of the PUSCH is confined within UL subband, the slot is counted as available slot. If at least one of PRBs of the PUSCH is outside UL subband, the slot is counted as unavailable slot. If the symbol is flexible symbol based on semi-static subband configuration, the slot is counted as available slot. In a second step, for an available slot determined in the first step, if UE identifies the frequency domain resource of the PUSCH/PUCCH/SRS to collide with valid DL subband and guard band provided by dynamic subband information, or if UE identifies the PUSCH/PUCCH/SRS to collide with legacy DL symbol (non-SBFD symbol) provided by dynamic subband information, the UE cancels the PUSCH/PUCCH/SRS.

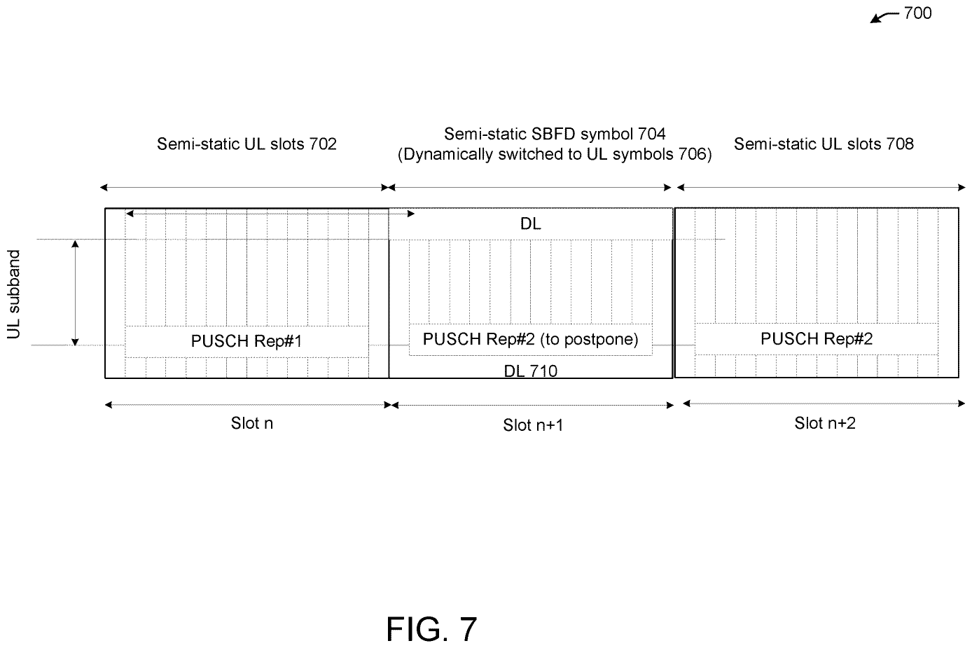

FIG. 7 illustrates an example PUSCH repetition 700 in a semi-statically configured SBFD symbol dynamically switched to an uplink symbol, in accordance with one or more example embodiments of the present disclosure.

FIG. 7 provides an example of PUSCH with two repetitions. There may be semi-static UL slots 702, semi-static SBFD symbols 704 dynamically switched to UL symbols 706, and semi-static UL slots 708. Slot n+1 consists of a semi-static SBFD symbol 704 based on a semi-static sub-band configuration, and the symbols are dynamically switched to legacy UL symbols 706 based on dynamic sub-band information. For PUSCH repetition #2 in slot n+1, a frequency resource of the PUSCH is determined with reference to UL BWP. Since the PUSCH overlaps with a semi-static DL sub-band 710, the PUSCH repetition #2 is postponed to next slot n+2 with semi-static UL slot. The slot n+1 is not counted as available slot in the first step. A UE (e.g., the UE 902 of FIG. 9) does not check slot n+1 in the second step though the slot n+1 is switched to full UL slot.

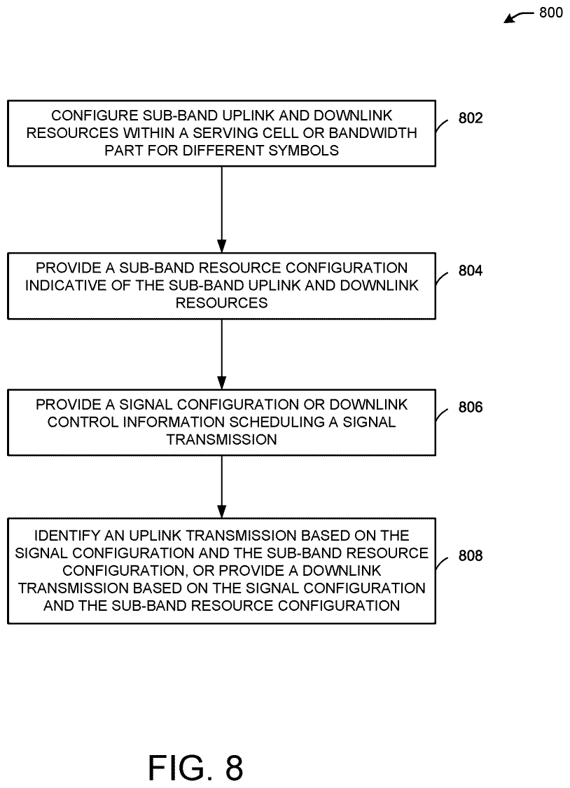

FIG. 8 illustrates a flow diagram of illustrative process 800 for SBFD-based resource allocation in a serving cell, in accordance with one or more example embodiments of the present disclosure.

Referring to block 802, a device (e.g., the gNB 916 of FIG. 9) may configure UL sub-band resources (e.g., an uplink time and uplink frequency) and DL sub-band resources (e.g., a downlink time and a downlink frequency) within a serving cell or bandwidth part for different symbols.

At block 804, the device may provide a frequency resource configuration to a UE, indicative of the UL sub-band resources and the DL sub-band resources.

At block 806, the device may provide a signal configuration or DCI scheduling a signal transmission between the device and the UE.

At block 808, the device may either identify a UL transmission from the UE or provide a DL transmission to the UE, based on the signal configuration and the sub-band resource configuration.

These embodiments are not meant to be limiting.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be communicatively coupled with the RAN 904 by a Uu interface. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 936 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 452 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3^{rd} party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

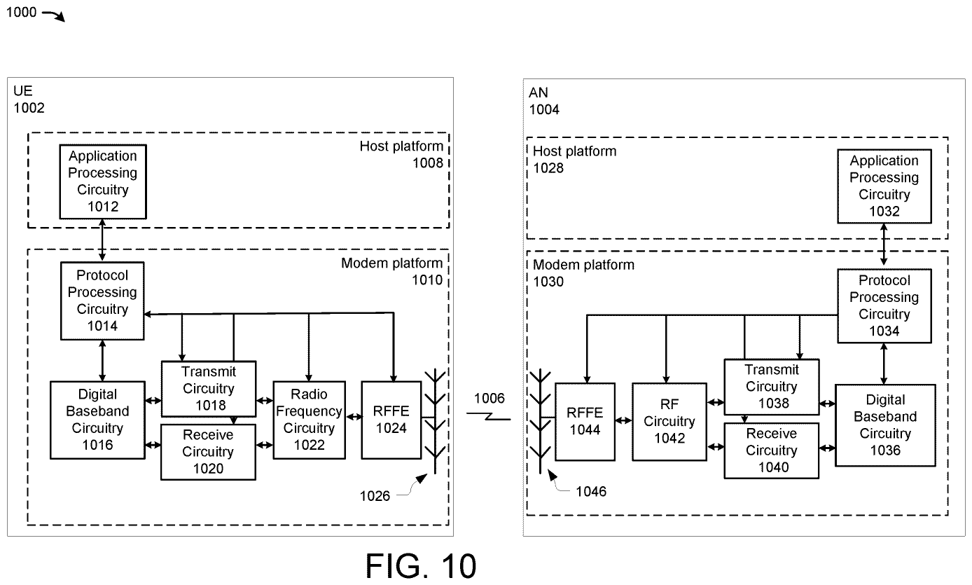

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

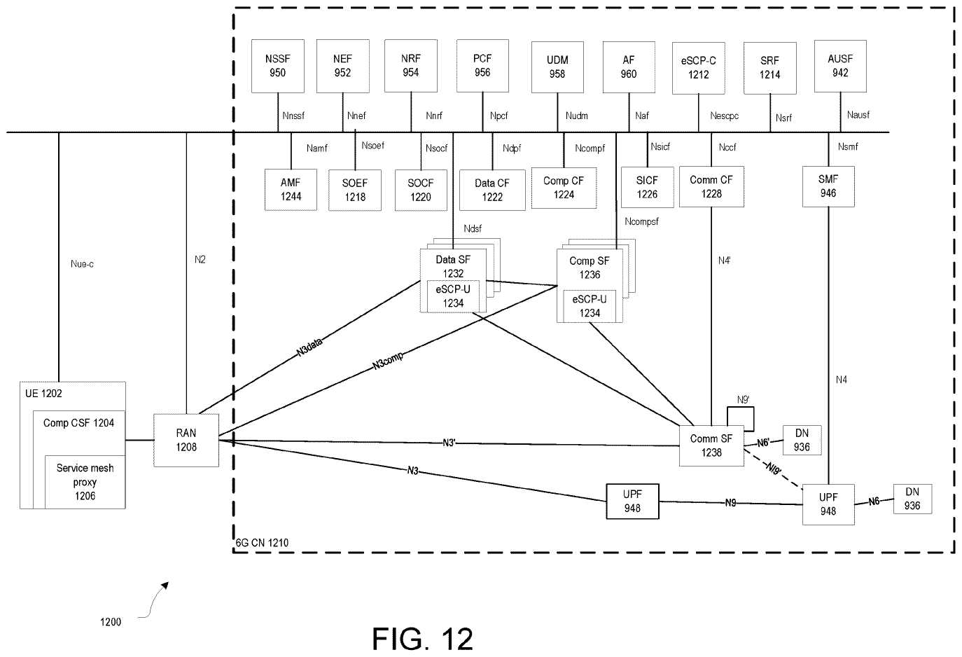

FIG. 12 illustrates a network, in accordance with one or more example embodiments of the present disclosure.

The network 1200 may operate in a matter consistent with 3GPP technical specifications or technical reports for 6G systems. In some examples, the network 1200 may operate concurrently with network 900. For example, in some examples, the network 1200 may share one or more frequency or bandwidth resources with network 900. As one specific example, a UE (e.g., UE 902) may be configured to operate in both network 1200 and network 900. Such configuration may be based on a UE including circuitry configured for communication with frequency and bandwidth resources of both networks 900 and 1200. In general, several elements of network 1200 may share one or more characteristics with elements of network 900. For the sake of brevity and clarity, such elements may not be repeated in the description of network 1200.

The network 1200 may include a UE 1202, which may include any mobile or non-mobile computing device designed to communicate with a RAN 1208 via an over-the-air connection. The UE 1202 may be similar to, for example, UE 902. The UE 1202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 12, in some examples the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 12, the UE 1202 may be communicatively coupled with an AP such as AP 906 as described with respect to FIG. 9. Additionally, although not specifically shown in FIG. 12, in some examples the RAN 1208 may include one or more ANs such as AN 908 as described with respect to FIG. 12. The RAN 1208 and/or the AN of the RAN 1208 may be referred to as a base station (BS), a RAN node, or using some other term or name.

The UE 1202 and the RAN 1208 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1208 may allow for communication between the UE 1202 and a 6G core network (CN) 1210. Specifically, the RAN 1208 may facilitate the transmission and reception of data between the UE 1202 and the 6G CN 1210. The 6G CN 1210 may include various functions such as NSSF 950, NEF 952, NRF 954, PCF 956, UDM 958, AF 960, SMF 946, and AUSF 942. The 6G CN 1210 may additional include UPF 948 and DN 936 as shown in FIG. 12.

Additionally, the RAN 1208 may include various additional functions that are in addition to, or alternative to, functions of a legacy cellular network such as a 4G or 5G network. Two such functions may include a Compute Control Function (Comp CF) 1224 and a Compute Service Function (Comp SF) 1236. The Comp CF 1224 and the Comp SF 1236 may be parts or functions of the Computing Service Plane. Comp CF 1224 may be a control plane function that provides functionalities such as management of the Comp SF 1236, computing task context generation and management (e.g., create, read, modify, delete), interaction with the underlaying computing infrastructure for computing resource management, etc. Comp SF 1236 may be a user plane function that serves as the gateway to interface computing service users (such as UE 1202) and computing nodes behind a Comp SF instance. Some functionalities of the Comp SF 1236 may include: parse computing service data received from users to compute tasks executable by computing nodes; hold service mesh ingress gateway or service API gateway; service and charging policies enforcement; performance monitoring and telemetry collection, etc. In some examples, a Comp SF 1236 instance may serve as the user plane gateway for a cluster of computing nodes. A Comp CF 1224 instance may control one or more Comp SF 1236 instances.

Two other such functions may include a Communication Control Function (Comm CF) 1228 and a Communication Service Function (Comm SF) 1238, which may be parts of the Communication Service Plane. The Comm CF 1228 may be the control plane function for managing the Comm SF 1238, communication sessions creation/configuration/releasing, and managing communication session context. The Comm SF 1238 may be a user plane function for data transport. Comm CF 1228 and Comm SF 1238 may be considered as upgrades of SMF 946 and UPF 948, which were described with respect to a 5G system in FIG. 9. The upgrades provided by the Comm CF 1228 and the Comm SF 1238 may enable service-aware transport. For legacy (e.g., 4G or 5G) data transport, SMF 946 and UPF 948 may still be used.

Two other such functions may include a Data Control Function (Data CF) 1222 and Data Service Function (Data SF) 1232 may be parts of the Data Service Plane. Data CF 1222 may be a control plane function and provides functionalities such as Data SF 1232 management, Data service creation/configuration/releasing, Data service context management, etc. Data SF 1232 may be a user plane function and serve as the gateway between data service users (such as UE 1202 and the various functions of the 6G CN 1210) and data service endpoints behind the gateway. Specific functionalities may include: parse data service user data and forward to corresponding data service endpoints, generate charging data, report data service status.

Another such function may be the Service Orchestration and Chaining Function (SOCF) 1220, which may discover, orchestrate and chain up communication/computing/data services provided by functions in the network. Upon receiving service requests from users, SOCF 1220 may interact with one or more of Comp CF 1224, Comm CF 1228, and Data CF 1222 to identify Comp SF 1236, Comm SF 1238, and Data SF 1232 instances, configure service resources, and generate the service chain, which could contain multiple Comp SF 1236, Comm SF 1238, and Data SF 1232 instances and their associated computing endpoints.

Workload processing and data movement may then be conducted within the generated service chain. The SOCF 1220 may also responsible for maintaining, updating, and releasing a created service chain.

Another such function may be the service registration function (SRF) 1214, which may act as a registry for system services provided in the user plane such as services provided by service endpoints behind Comp SF 1236 and Data SF 1232 gateways and services provided by the UE 1202. The SRF 1214 may be considered a counterpart of NRF 954, which may act as the registry for network functions.

Other such functions may include an evolved service communication proxy (eSCP) and service infrastructure control function (SICF) 1226, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1212 and eSCP-U 1234, for control plane service communication proxy and user plane service communication proxy, respectively. The SICF 1226 may control and configure eCSP instances in terms of service traffic routing policies, access rules, load balancing configurations, performance monitoring, etc.

Another such function is the AMF 1244. The AMF 1244 may be similar to 944, but with additional functionality. Specifically, the AMF 1244 may include potential functional repartition, such as move the message forwarding functionality from the AMF 1244 to the RAN 1208.

Another such function is the service orchestration exposure function (SOEF) 1218. The SOEF may be configured to expose service orchestration and chaining services to external users such as applications.

The UE 1202 may include an additional function that is referred to as a computing client service function (comp CSF) 1204. The comp CSF 1204 may have both the control plane functionalities and user plane functionalities, and may interact with corresponding network side functions such as SOCF 1220, Comp CF 1224, Comp SF 1236, Data CF 1222, and/or Data SF 1232 for service discovery, request/response, compute task workload exchange, etc. The Comp CSF 1204 may also work with network side functions to decide on whether a computing task should be run on the UE 1202, the RAN 1208, and/or an element of the 6G CN 1210.

The UE 1202 and/or the Comp CSF 1204 may include a service mesh proxy 1206. The service mesh proxy 1206 may act as a proxy for service-to-service communication in the user plane. Capabilities of the service mesh proxy 1206 may include one or more of addressing, security, load balancing, and/or the like.

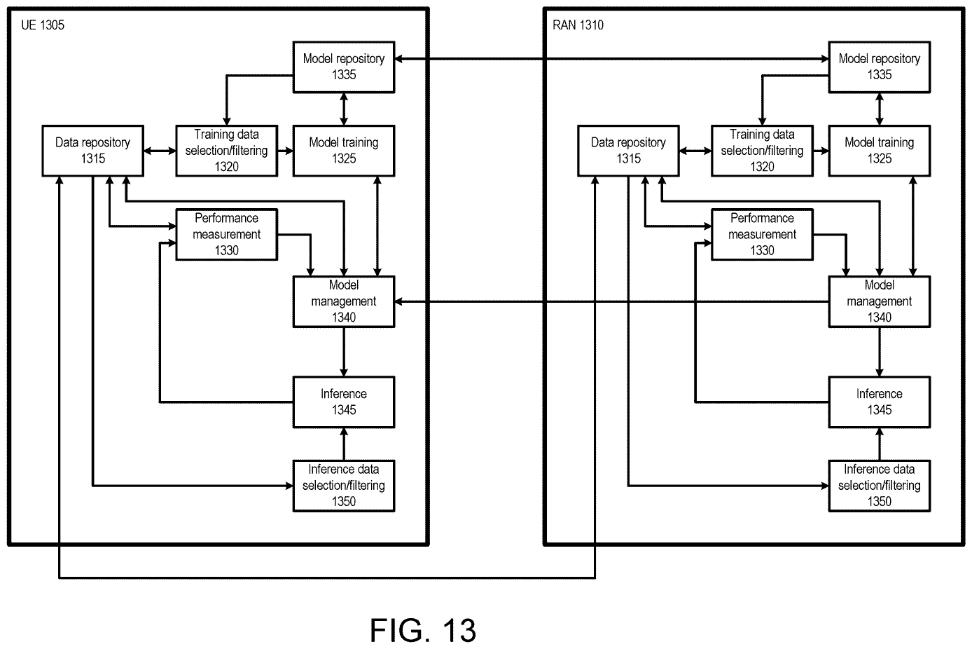

FIG. 13 illustrates a simplified block diagram of artificial (AI)-assisted communication between a user equipment and a radio access network, in accordance with one or more example embodiments of the present disclosure.

FIG. 13 depicts an example artificial (AI)-assisted communication architecture. More specifically, as described in further detail below, AI/machine learning (ML) models may be used or leveraged to facilitate over-the-air communication between UE 1305 and RAN 1310.

In this example, the UE 1305 and the RAN 1310 operate in a matter consistent with 3GPP technical specifications and/or technical reports for 6G systems. In some examples, the wireless cellular communication between the UE 1305 and the RAN 1310 may be part of, or operate concurrently with, networks 900, 1200, and/or some other network described herein.

The UE 1305 may be similar to, and share one or more features with, UE 902, UE 1202, and/or some other UE described herein. The UE 1305 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1310 may be similar to, and share one or more features with, RAN 914, RAN 1208, and/or some other RAN described herein.

As may be seen in FIG. 13, the AI-related elements of UE 1305 may be similar to the AI-related elements of RAN 1310. For the sake of discussion herein, description of the various elements will be provided from the point of view of the UE 1305, however it will be understood that such discussion or description will apply to equally named/numbered elements of RAN 1310, unless explicitly stated otherwise.

As previously noted, the UE 1305 may include various elements or functions that are related to AI/ML. Such elements may be implemented as hardware, software, firmware, and/or some combination thereof. In examples, one or more of the elements may be implemented as part of the same hardware (e.g., chip or multi-processor chip), software (e.g., a computing program), or firmware as another element.

One such element may be a data repository 1315. The data repository 1315 may be responsible for data collection and storage. Specifically, the data repository 1315 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1315. For example, as may be seen, the inference data selection/filter element 1350 may retrieve data from the data repository 1315. In various examples, the UE 1305 may be configured to discover and request data from the data repository 1315 in the RAN, and vice versa. More generally, the data repository 1315 of the UE 1305 may be communicatively coupled with the data repository 1315 of the RAN 1310 such that the respective data repositories of the UE and the RAN may share collected data with one another.

Another such element may be a training data selection/filtering functional block 1320. The training data selection/filter functional block 1320 may be configured to generate training, validation, and testing datasets for model training. Training data may be extracted from the data repository 1315. Data may be selected/filtered based on the specific AI/ML model to be trained. Data may optionally be transformed/augmented/pre-processed (e.g., normalized) before being loaded into datasets. The training data selection/filter functional block 1320 may label data in datasets for supervised learning. The produced datasets may then be fed into model training the model training functional block 1325.

As noted above, another such element may be the model training functional block 1325. This functional block may be responsible for training and updating(re-training) AI/ML models. The selected model may be trained using the fed-in datasets (including training, validation, testing) from the training data selection/filtering functional block. The model training functional block 1325 may produce trained and tested AI/ML models which are ready for deployment. The produced trained and tested models can be stored in a model repository 1335.

The model repository 1335 may be responsible for AI/ML models' (both trained and un-trained) storage and exposure. Trained/updated model(s) may be stored into the model repository 1335. Model and model parameters may be discovered and requested by other functional blocks (e.g., the training data selection/filter functional block 1320 and/or the model training functional block 1325). In some examples, the UE 1305 may discover and request AI/ML models from the model repository 1335 of the RAN 1310. Similarly, the RAN 1310 may be able to discover and/or request AI/ML models from the model repository 1335 of the UE 1305. In some examples, the RAN 1310 may configure models and/or model parameters in the model repository 1335 of the UE 1305.

Another such element may be a model management functional block 1340. The model management functional block 1340 may be responsible for management of the AI/ML model produced by the model training functional block 1325. Such management functions may include deployment of a trained model, monitoring model performance, etc. In model deployment, the model management functional block 1340 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1340 may decide to terminate the running model, start model re-training, select another model, etc. In examples, the model management functional block 1340 of the RAN 1310 may be able to configure model management policies in the UE 1305 as shown.

Another such element may be an inference data selection/filtering functional block 1350. The inference data selection/filter functional block 1350 may be responsible for generating datasets for model inference at the inference functional block 1345, as described below. Specifically, inference data may be extracted from the data repository 1315. The inference data selection/filter functional block 1350 may select and/or filter the data based on the deployed AI/ML model. Data may be transformed/augmented/pre-processed following the same transformation/augmentation/pre-processing as those in training data selection/filtering as described with respect to functional block 1320. The produced inference dataset may be fed into the inference functional block 1345.

Another such element may be the inference functional block 1345. The inference functional block 1345 may be responsible for executing inference as described above. Specifically, the inference functional block 1345 may consume the inference dataset provided by the inference data selection/filtering functional block 1350, and generate one or more outcomes. Such outcomes may be or include data analytics, actions, policies, etc. The outcome(s) may be provided to the performance measurement functional block 1330.

The performance measurement functional block 1330 may be configured to measure model performance metrics (e.g., accuracy, model bias, run-time latency, etc.) of deployed and executing models based on the inference outcome(s) for monitoring purpose. Model performance data may be stored in the data repository 1315.

The following examples pertain to further embodiments.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.

Example 1 may include a Next Generation Node B (gNB) device for configuring uplink and downlink transmissions in a full duplex system, the gNB device comprising processing circuitry coupled to storage for storing information associated with the configuring, the processing circuitry configured to: configure uplink sub-band resources and downlink sub-band resources within a serving cell or bandwidth part for different symbols, wherein the uplink sub-band resources comprise an uplink time and an uplink frequency resource, and wherein the downlink sub-band resources comprise a downlink time and a downlink frequency resource; provide a sub-band resource configuration, indicative of the uplink time, the uplink frequency resource, the downlink time, and the downlink frequency resource, to a user equipment (UE); provide, to the UE, a signal configuration or downlink control information (DCI) scheduling a signal transmission; and detect an uplink transmission from the UE based on the signal configuration and the sub-band resource configuration, or provide a downlink transmission to the UE based on the signal configuration and the sub-band resource configuration.

Example 2 may include the gNB device of example 1 and/or any other example herein, wherein the sub-band resource configuration comprises a time domain configuration of at least one of an uplink symbol, a downlink symbol, or a flexible symbol, comprising sub-band frequency information, signaled by semi-static signaling or dynamic signaling.

Example 3 may include the gNB device of example 1 and/or any other example herein, wherein the sub-band resource configuration uses dynamic signaling carried by a bit field in a downlink assignment or an uplink grant DCI, or by DCI other than DCI used for downlink assignment or uplink grant.

Example 4 may include the gNB device of example 3 and/or any other example herein, wherein the dynamic signaling by the bit field in the downlink assignment or the uplink grant DCI indicates that a set of symbols are with or without a flexible sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.

Example 5 may include the gNB device of example 1 and/or any other example herein, wherein the sub-band resource configuration uses semi-static signaling.

Example 6 may include the gnB device of example 5 and/or any other example herein, wherein the uplink transmission from the UE or the downlink transmission to the UE is based on dynamic signaling.

Example 7 may include the gnB device of example 1 and/or any other example herein, wherein the sub-band resource configuration uses dynamic signaling.

Example 8 may include the gnB device of example 7 and/or any other example herein, wherein an available slot for the UE is based on the sub-band resource configuration using semi-static signaling, and wherein the sub-band resource configuration is indicative of whether the UE should transmit or drop the uplink transmission based on dynamic signaling during the available slot if the uplink transmission repetition overlaps with symbols related to a different sub-band resource configuration.

Example 9 may include a computer-readable storage medium comprising instructions to cause processing circuitry of a user equipment (UE) device for configuring uplink and downlink transmissions in a full duplex system, upon execution of the instructions by the processing circuitry, to: identify, from a Next Generation Node B (gNB) device, a sub-band resource configuration, indicative of an uplink time, and uplink frequency resource, a downlink time, and a downlink frequency resource within a serving cell or bandwidth part for different symbols; identify, from the gNB device, a signal configuration or downlink control information (DCI) scheduling a signal transmission; and identify a downlink transmission from the gNB device based on the signal configuration and the sub-band resource configuration, or provide, to the gNB device, an uplink transmission based on the sub-band resource configuration.

Example 10 may include the computer-readable storage medium of example 9 and/or any other example herein, wherein the sub-band resource configuration comprises a time domain configuration of at least one of an uplink symbol, a downlink symbol, or a flexible symbol, comprising sub-band information, signaled by semi-static signaling or dynamic signaling.

Example 11 may include the computer-readable storage medium of example 9 and/or any other example herein, wherein the sub-band resource configuration uses dynamic signaling carried by a bit field in a downlink assignment or an uplink grant DCI, or by DCI other than DCI used for downlink assignment or uplink grant.

Example 12 may include the computer-readable storage medium of example 11 and/or any other example herein, wherein the dynamic signaling by the bit field in the downlink assignment or the uplink grant DCI indicates that a set of symbols are with or without a flexible sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.

Example 13 may include the computer-readable storage medium of example 9 and/or any other example herein, wherein the frequency resource configuration uses semi-static signaling.

Example 14 may include the computer-readable storage medium of example 13 and/or any other example herein, wherein the uplink transmission from the UE device or the downlink transmission to the UE device is based on dynamic signaling.

Example 15 may include the computer-readable storage medium of example 9 and/or any other example herein, wherein the sub-band resource configuration uses dynamic signaling.

Example 16 may include the computer-readable storage medium of example 15 and/or any other example herein, wherein an available slot for the UE device is based on the sub-band resource configuration using semi-static signaling, and wherein the sub-band resource configuration is indicative of whether the UE device should transmit or drop the uplink transmission based on dynamic signaling during the available slot if the uplink transmission repetition overlaps with symbols related to a different sub-band resource configuration.

Example 17 a method for configuring uplink and downlink transmissions in a full duplex system, the method comprising: configuring, by processing circuitry of a Next Generation Node B (gNB) device, uplink sub-band resources and downlink sub-band resources within a serving cell or bandwidth part for different symbols, wherein the uplink sub-band resources comprise an uplink time and an uplink frequency resource, and wherein the downlink sub-band resources comprise a downlink time and a downlink frequency resource; providing, by the processing circuitry, a sub-band resource configuration, indicative of the uplink time, the uplink frequency resource, the downlink time, and the downlink frequency resource, to a user equipment (UE); providing, by the processing circuitry, to the UE, a signal configuration or downlink control information (DCI) scheduling a signal transmission; and identifying, by the processing circuitry, an uplink transmission from the UE based on the signal configuration and the sub-band resource configuration, or provide a downlink transmission to the UE based on the signal configuration and the sub-band resource configuration.

Example 18 may include the method of example 17 and/or any other example herein, wherein the sub-band resource configuration comprises a time domain configuration of at least one of an uplink symbol, a downlink symbol, or a flexible symbol, comprising sub-band information, signaled by semi-static signaling or dynamic signaling.

Example 19 may include the method of example 17 and/or any other example herein, wherein the sub-band resource configuration uses dynamic signaling carried by a bit field in a downlink assignment or an uplink grant DCI, or by DCI other than DCI used for downlink assignment or uplink grant.

Example 20 may include the method of example 19 and/or any other example herein, wherein the dynamic signaling by the bit field in the downlink assignment or the uplink grant DCI indicates that a set of symbols are with or without a sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.

Example 21 may include the method of example 17 and/or any other example herein, wherein the sub-band resource configuration uses semi-static signaling.

Example 22 may include the method of example 21 and/or any other example herein, wherein the uplink transmission from the UE or the downlink transmission to the UE is based on dynamic signaling.

Example 23 may include the method of example 22 and/or any other example herein, wherein the sub-band resource configuration uses dynamic signaling.

Example 24 may include an apparatus comprising means for: configuring, by a Next Generation Node B (gNB) device, uplink sub-band resources and downlink sub-band resources within a serving cell or bandwidth part for different symbols, wherein the uplink sub-band resources comprise an uplink time and an uplink frequency resource, and wherein the downlink sub-band resources comprise a downlink time and a downlink frequency resource; providing a sub-band resource configuration, indicative of the uplink time, the uplink frequency resource, the downlink time, and the downlink frequency resource, to a user equipment (UE); providing, to the UE, a signal configuration or downlink control information (DCI) scheduling a signal transmission; and identifying an uplink transmission from the UE based on the signal configuration and the sub-band resource configuration, or provide a downlink transmission to the UE based on the signal configuration and the sub-band resource configuration.

Example 25 may include one or more non-transitory computer-readable media comprising instructions to cause an electronic device, upon execution of the instructions by one or more processors of the electronic device, to perform one or more elements of a method described in or related to any of examples 1-24, or any other method or process described herein Example 26 may include an apparatus comprising logic, modules, and/or circuitry to perform one or more elements of a method described in or related to any of examples 1-24, or any other method or process described herein.

Example 27 may include a method, technique, or process as described in or related to any of examples 1-24, or portions or parts thereof.

Example 28 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 29 may include a method of communicating in a wireless network as shown and described herein.

Example 30 may include a system for providing wireless communication as shown and described herein.

Example 31 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 1) may apply to the examples and embodiments discussed herein.

TABLE 1
Abbreviations

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, |
| | Antenna Port, |
| | Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, |
| | Certification Authority |
| CAPEX | CAPital Expenditure |
| CBRA | Contention Based Random Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, |
| | Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, |
| | Central Processing Unit |
| C/R | Command/Response field bit |
| CRAN | Cloud Radio Access Network, |
| | Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, |
| | Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, |
| | extended CCA |
| ECCE | Enhanced Control Channel Element, |
| | Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance tableManagement Function |
| EGPRS | Enhanced GPRS |
| EIR | Equipment Identity Register |
| eLAA | enhanced Licensed Assisted Access, |
| | enhanced LAA |
| EM | Element Manager |
| eMBB | Enhanced Mobile Broadband |
| EMS | Element Management System |
| eNB | evolved NodeB, |
| | E-UTRAN Node B |
| EN-DC | E-UTRA-NR Dual Connectivity |
| EPC | Evolved Packet Core |
| EPDCCH | enhanced PDCCH, |
| | enhanced Physical Downlink Control Cannel |
| EPRE | Energy per resource element |
| EPS | Evolved Packet System |
| EREG | enhanced REG, |
| | enhanced resource element groups |
| ETSI | European Telecommunications Standards Institute |
| ETWS | Earthquake and Tsunami Warning System |
| eUICC | embedded UICC, |
| | embedded Universal Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema |
| | (Engl.: Global Navigation Satellite System) |
| gNB | Next Generation NodeB |
| gNB-CU | gNB-centralized unit, |
| | Next Generation NodeB centralized unit |
| gNB-DU | gNB-distributed unit, |
| | Next Generation NodeB distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Special Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, |
| | Intermodulation, |
| | IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, |
| | Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IR | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN |

Constraint length of the
convolutional code, USIM
Individual key

| | |
|---|---|
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling |
| | messages (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, |
| | Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, |
| | Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, |
| | MCH Scheduling Information |
| MSID | Mobile Station Identifier |
| MSIN | Mobile Station Identification Number |
| MSISDN | Mobile Subscriber ISDN Number |
| MT | Mobile Terminated, |
| | Mobile Termination |
| MTC | Machine-Type Communications |
| mMTC | massive MTC, |
| | massive Machine-Type Communications |
| MU-MIMO | Multi User MIMO |
| MWUS | MTC wake-up signal, |
| | MTC WUS |
| NACK | Negative Acknowledgement |
| NAI | Network Access Identifier |
| NAS | Non-Access Stratum, |
| | Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, |
| | Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, |
| | Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, |
| | Narrowband WUS |
| NZP | Non-Zero Power |
| O&M | Operation and Maintenance |
| ODU2 | Optical channel Data Unit-type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, |
| | Personal Computer |
| PCC | Primary Component Carrier, |
| | Primary CC |
| PCell | Primary Cell |
| PCI | Physical Cell ID, |
| | Physical Cell Identity |
| PCEF | Policy and Charging Enforcement Function |
| PCF | Policy Control Function |
| PCRF | Policy Control and Charging Rules Function |
| PDCP | Packet Data Convergence Protocol, |
| | Packet Data Convergence Protocol layer |
| PDCCH | Physical Downlink Control Channel |
| PDCP | Packet Data Convergence Protocol |
| PDN | Packet Data Network, |
| | Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, |
| | Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, |
| | QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, |
| | Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, |
| | Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, |
| | Remaining Minimum System Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, |
| | Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, |
| | Receiving, |
| | Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, |
| | Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, |
| | Service Data Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, |
| | SFN and frame timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, |
| | Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, |
| | Technical Standard |
| TTI | Transmission Time Interval |
| Tx | Transmission, |
| | Transmitting, |
| | Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, |
| | Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, |
| | Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

What is claimed is:

1.-20. (canceled)

21. A Next Generation Node B (gNB) device for configuring uplink and downlink transmissions in a full duplex system, the gNB device comprising processing circuitry coupled to storage for storing information associated with the configuring, the processing circuitry configured to:
configure uplink sub-band resources and downlink sub-band resources within a serving cell or bandwidth part for different symbols, wherein the uplink sub-band resources comprise an uplink time and an uplink frequency resource, and wherein the downlink sub-band resources comprise a downlink time and a downlink frequency resource;
provide a sub-band resource configuration, indicative of the uplink time, the uplink frequency resource, the downlink time, and the downlink frequency resource, to a user equipment (UE);
provide, to the UE, a signal configuration or downlink control information (DCI) scheduling a signal transmission; and
detect an uplink transmission from the UE based on the signal configuration and the sub-band resource configuration, or provide a downlink transmission to the UE based on the signal configuration and the sub-band resource configuration.

22. The gNB device of claim 21, wherein the sub-band resource configuration comprises a time domain configuration of at least one of an uplink symbol, a downlink symbol, or a flexible symbol, comprising sub-band frequency information, signaled by semi-static signaling or dynamic signaling.

23. The gNB device of claim 21, wherein the sub-band resource configuration uses dynamic signaling carried by a bit field in a downlink assignment or an uplink grant DCI, or by DCI other than DCI used for downlink assignment or uplink grant.

24. The gNB device of claim 23, wherein the dynamic signaling by the bit field in the downlink assignment or the uplink grant DCI indicates that a set of symbols are with or without a flexible sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.

25. The gNB device of claim 21, wherein the sub-band resource configuration uses semi-static signaling.

26. The gnB device of claim 25, wherein the uplink transmission from the UE or the downlink transmission to the UE is based on dynamic signaling.

27. The gnB device of claim 21, wherein the sub-band resource configuration uses dynamic signaling.

28. The gnB device of claim 27, wherein an available slot for the UE is based on the sub-band resource configuration using semi-static signaling, and wherein the sub-band resource configuration is indicative of whether the UE should transmit or drop the uplink transmission based on dynamic signaling during the available slot if the uplink transmission repetition overlaps with symbols related to a different sub-band resource configuration.

29. A non-transitory computer-readable storage medium comprising instructions to cause processing circuitry of a user equipment (UE) device for configuring uplink and downlink transmissions in a full duplex system, upon execution of the instructions by the processing circuitry, to:
identify, from a Next Generation Node B (gNB) device, a sub-band resource configuration, indicative of an uplink time, and uplink frequency resource, a downlink time, and a downlink frequency resource within a serving cell or bandwidth part for different symbols;
identify, from the gNB device, a signal configuration or downlink control information (DCI) scheduling a signal transmission; and
identify a downlink transmission from the gNB device based on the signal configuration and the sub-band resource configuration, or provide, to the gNB device, an uplink transmission based on the sub-band resource configuration.

30. The non-transitory computer-readable storage medium of claim 29, wherein the sub-band resource configuration comprises a time domain configuration of at least one of an uplink symbol, a downlink symbol, or a flexible symbol, comprising sub-band information, signaled by semi-static signaling or dynamic signaling.

31. The non-transitory computer-readable storage medium of claim 29, wherein the sub-band resource configuration uses dynamic signaling carried by a bit field in a downlink assignment or an uplink grant DCI, or by DCI other than DCI used for downlink assignment or uplink grant.

32. The non-transitory computer-readable storage medium of claim 31, wherein the dynamic signaling by the bit field in the downlink assignment or the uplink grant DCI indicates that a set of symbols are with or without a flexible sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.

33. The non-transitory computer-readable storage medium of claim 29, wherein the frequency resource configuration uses semi-static signaling.

34. The non-transitory computer-readable storage medium of claim 33, wherein the uplink transmission from the UE device or the downlink transmission to the UE device is based on dynamic signaling.

35. The non-transitory computer-readable storage medium of claim 29, wherein the sub-band resource configuration uses dynamic signaling.

36. The non-transitory computer-readable storage medium of claim 35, wherein an available slot for the UE device is based on the sub-band resource configuration using semi-static signaling, and wherein the sub-band resource configuration is indicative of whether the UE device should transmit or drop the uplink transmission based on dynamic signaling during the available slot if the uplink transmission repetition overlaps with symbols related to a different sub-band resource configuration.

37. A method for configuring uplink and downlink transmissions in a full duplex system, the method comprising:
configuring, by processing circuitry of a Next Generation Node B (gNB) device, uplink sub-band resources and downlink sub-band resources within a serving cell or bandwidth part for different symbols, wherein the uplink sub-band resources comprise an uplink time and an uplink frequency resource, and wherein the downlink sub-band resources comprise a downlink time and a downlink frequency resource;
providing, by the processing circuitry, a sub-band resource configuration, indicative of the uplink time, the uplink frequency resource, the downlink time, and the downlink frequency resource, to a user equipment (UE);
providing, by the processing circuitry, to the UE, a signal configuration or downlink control information (DCI) scheduling a signal transmission; and
identifying, by the processing circuitry, an uplink transmission from the UE based on the signal configuration and the sub-band resource configuration, or providing a downlink transmission to the UE based on the signal configuration and the sub-band resource configuration.

38. The method of claim 37, wherein the sub-band resource configuration comprises a time domain configuration of at least one of an uplink symbol, a downlink symbol, or a flexible symbol, comprising sub-band information, signaled by semi-static signaling or dynamic signaling.

39. The method of claim 37, wherein the sub-band resource configuration uses dynamic signaling carried by a bit field in a downlink assignment or an uplink grant DCI, or by DCI other than DCI used for downlink assignment or uplink grant.

40. The method of claim 39, wherein the dynamic signaling by the bit field in the downlink assignment or the uplink grant DCI indicates that a set of symbols are with or without a flexible sub-band, wherein the set of symbols are of a physical downlink shared control channel (PDSCH) scheduled by the downlink assignment or are of a physical uplink shared control channel (PUSCH) scheduled by the uplink grant, or wherein all symbols are of a time slot in which the PDSCH is scheduled by the downlink assignment or the PUSCH is scheduled by the uplink grant.
